(19) United States
(12) Patent Application Publication
(10) Pub. No.: US 2022/0372334 A1
(43) Pub. Date: Nov. 24, 2022

(54) PRE-ADHESIVE REACTION MIXTURES AND ACRYLIC MICROSPHERE ADHESIVES INCLUDING THE SAME

(71) Applicant: 3M INNOVATIVE PROPERTIES COMPANY, St. Paul, MN (US)

(72) Inventors: Michael J. Maher, St. Paul, MN (US); Bradley S. Forney, Cottage Grove, MN (US); Roselynn Campoverde, Woodbury, MN (US); Intaek Lee, Seoul (KR)

(21) Appl. No.: 17/765,916

(22) PCT Filed: Oct. 13, 2020
(86) PCT No.: PCT/IB2020/059600

§ 371 Date: Apr. 1, 2022

Related U.S. Application Data
(60) Provisional application No. 62/923,156, filed on Oct. 18, 2019.
(60) Provisional application No. 63/002,527, filed on Mar. 31, 2020.

(51) Int. Cl. C09J 4/00; C09J 7/38; C09J 133/10; C09J 11/08

(52) U.S. Cl. CPC C09J 4/00; C09J 7/38; C09J 133/10; C09J 11/08; C09J 2301/302; C09J 2301/408

(57) ABSTRACT

Pressure-sensitive adhesive compositions that contain polymer microspheres with an average particle size of 20 μm to 100 μm, the polymer microspheres synthesized using the disclosed suspension polymerization techniques and include at least three structural isomers of a secondary (meth)acrylate of Formula (I), where R¹ and R² are each independently H or a C₁ to C₁₀ saturated linear alkyl group, the sum of the number of carbons in R¹ and R² is 7 to 18, inclusive, and R³ is H or CH₃. The disclosed pressure-sensitive adhesive compositions may be used in masking articles to provide holding power to, clean paint-lines on, low surface energy adhesion to, and excellent damage-free removal from painted surfaces.

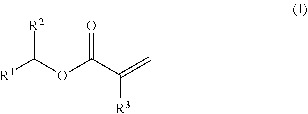

### BACKGROUND

When applying a surface coating, such as paint or stain, to a surface, care must be taken so that the paint does not get on the surfaces adjacent to the surface to be painted. This can be accomplished by carefully painting the surface, or by masking off the area around the surface to be painted. Masking articles, such as masking tapes and adhesive masking sheets, are often used to protect the area adjacent to the surface being painted. When using such masking articles, it is generally desirable that the paint not bleed past the demarcation line defined by the edge of the masking article. In this manner, the masking article will produce a paint line between the painted surface and unpainted surface that is smooth and consistent, and precisely matches the line intended by the user.

Depending on a number of factors, such as how well such masking articles are applied to the surface, the surface free energy, and the texture of the surface to which such masking articles are applied, paint may flow beyond the edge of the masking article and under certain regions of the masking article, thereby producing an imprecise paint line.

### SUMMARY

In one aspect the present disclosure provides pressure-sensitive adhesive compositions that contain polymer microspheres with an average particle size of 20 μm to 100 μm. These polymer microspheres are synthesized using the disclosed suspension polymerization techniques and include at least three structural isomers of a secondary (meth)acrylate of Formula (I):

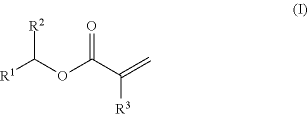

where R¹ and R² are each independently H or a C₁ to C₁₀ saturated linear alkyl group, the sum of the number of carbons in R¹ and R² is 7 to 18, inclusive, and R³ is H or CH₃. The disclosed pressure-sensitive adhesive compositions when used, for example, in a masking article, desirably provide holding power to, clean paint-lines on, low surface energy adhesion to, and excellent damage-free removal from painted surfaces.

In another aspect, provided are methods of making an adhesive article, the method comprising: forming an aqueous polymerizable pre-adhesive reaction mixture according to the present disclosure; polymerizing the monomers in the pre-adhesive reaction mixture to form a polymerized mixture, where the average particle size of polymers in the polymerized mixture is 20 μm to 100 μm, optionally 30 μm to 80 μm; coating the polymerized mixture onto a support to form a coated mixture; and drying the coated mixture. In some embodiments, the method further includes the step of adding a material selected from the group consisting of a binder, a base, a rheology modifier, an antioxidant, a biocide, and combinations thereof to the polymerized mixture. In some embodiments, the material is a binder.

The terms “polymer” and “polymeric material” include, but are not limited to, organic copolymers, such as for example, block, graft (including starblock), random and alternating copolymers, and blends and modifications thereof. Furthermore, unless otherwise specifically limited, the term “polymer” shall include all possible geometrical configurations of the material. These configurations include, but are not limited to, isotactic, syndiotactic, and atactic symmetries. The polymers can be homopolymers, copolymers, terpolymers, etc. Copolymer is used herein to encompass polymers made from two or more different monomers, including terpolymers, tetrapolymers, etc. The term polymer and/or copolymer is used regardless of the molecular weight and includes what is sometimes referred to as an oligomer.

Pressure-sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The terms “glass transition temperature” and “Tg” are used interchangeably. Typically, Tg values are measured using Dynamic Mechanical Analysis (“DMA”), unless otherwise noted.

The term “room temperature” refers to ambient temperature, generally 20-23° C., unless otherwise noted.

The term “high Tg monomer” refers to a monomer or monomeric unit that has a glass transition temperature of at least 25° C., at least 35° C., or at least 50° C. when homopolymerized.

The term “(meth)acrylate” refers to monomeric acrylic or methacrylic esters of alcohols. Acrylate and methacrylate monomers are referred to collectively herein as “(meth)acrylates”. Polymers described as being “(meth)acrylate-based” are polymers or copolymers prepared primarily (greater than 50% by weight (wt-%), greater than 60 wt-%, greater than 70 wt-%, greater than 80 wt-%, greater than 90 wt-%, greater than 95 wt-%, or 100 wt-%) from (meth)acrylate monomers and may include additional ethylenically unsaturated monomers such as various (meth)acrylamide monomers or various vinyl monomers that do not have a (meth)acryloyl group.

As used herein, the terms “polymerizable” or “curable” are applied to the compounds, also called “monomers,” that are polymerizable and/or crosslinkable as a result of initiation by thermal decomposition, redox reaction, or photolysis. Such compounds have at least one alpha, beta-unsaturated site (i.e., an ethylenically unsaturated site). In some embodiments, monomers having more than one alpha, beta-unsaturated site are termed “crosslinkers,” but it will be understood that the term “monomer” includes, as appropriate in context, compounds having more than one such site.

As used herein, the term “adhesive composition” or like term includes (1) at least three structural isomers of a secondary (meth)acrylate of Formula (I):

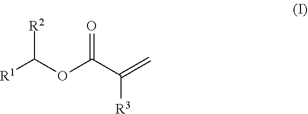

where R¹ and R² are each independently H or a C₁ to C₁₀ saturated linear alkyl group, the sum of the number of carbons in R¹ and R² is 7 to 18, inclusive, and R³ is H or CH₃, (2) a stabilizer, and (3) one or more additional components blended therewith, wherein the adhesive composition is typically a pressure sensitive adhesive composition.

As used herein, the term “adhesive article” means a support having an adhesive composition coated thereon. Supports are any useful material capable of having the adhesive compositions coated thereon for use in a pressure sensitive adhesive application. An adhesive article may be a masking article, though it is not a requirement that the adhesive article be used in a masking application. In some embodiments, for example, the support may be a release liner and the adhesive article may be, for example, a transfer tape. Adhesive articles include adhesive tapes, which can be used as a masking tape.

As used herein, the term “masking” means substantially preventing one or more liquids or liquid-borne materials from penetrating the interface of the adhesive composition and a substrate onto which an adhesive article is applied. As used herein in context with a masking application, the substrate onto which the adhesive article is applied is a “masked substrate.” As used herein in context with a masking application, the portion of the substrate surface covered by the adhesive article and in contact with the adhesive composition is the “masked surface.” Masking is achieved when one or more liquids or liquid-borne materials applied to the masked substrate are substantially prevented from contacting the masked surface.

As used herein, the term “substantial” or “substantially” means with relatively minor fluctuations or aberrations from the stated property, value, range of values, content, formula, and the like, and does not exclude the presence of additional materials, broader range values, and the like which do not materially affect the desired characteristics of a given composition, article, product, or method.

Herein, the terms “comprises” and “includes” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful and is not intended to exclude other claims from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “includes at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

Features and advantages of the present disclosure will be further understood upon consideration of the detailed description as well as the appended claims.

### DETAILED DESCRIPTION

The present disclosure provides adhesive compositions that include polymer microspheres with an average particle size of 20 μm to 100 μm. The polymer microspheres are synthesized using the disclosed suspension polymerization techniques and include at least three structural isomers of a secondary (meth)acrylate of Formula (I):

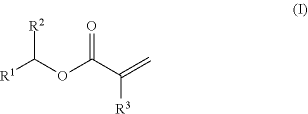

where R¹ and R² are each independently H or a C₁ to C₁₀ saturated linear alkyl group, the sum of the number of carbons in R¹ and R² is 7 to 18, inclusive, and R³ is H or CH₃. Aqueous polymerizable pre-adhesive reaction mixtures (also referred to as “aqueous pre-adhesive reaction mixtures” or “pre-adhesive reaction mixture” or “polymerizable pre-adhesive reaction mixtures” or like term) are also provided that include water, the monomer composition used to form the polymer microspheres, and a stabilizer. The monomer composition contains at least three structural isomers of a secondary (meth)acrylate of Formula (I):

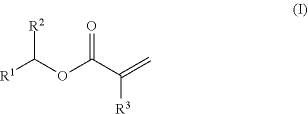

where R¹ and R² are each independently H or a C₁ to C₁₀ saturated linear alkyl group, the sum of the number of carbons in R¹ and R² is 7 to 18, inclusive, and R³ is H or CH₃, and optionally one or more high Tg monomers. Further, the polymerized products of the pre-adhesive reaction mixtures are provided, as well as methods of preparation of the adhesive compositions wherein the polymer microspheres are formed in the presence of the stabilizer and optionally in the presence of suspension particles (e.g., a latex).

### Monomer Composition

Polymer microspheres of the present disclosure are copolymers including the reaction products of polymerizable monomers, i.e., monomer composition, in particular, structural isomers of a secondary (meth)acrylate of Formula (I):

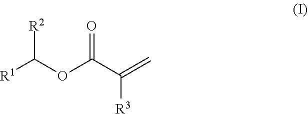

where R¹ and R² are each independently H or a C₁ to C₁₀ saturated linear alkyl group, the sum of the number of carbons in R¹ and R² is 7 to 18, inclusive, and R³ is H or CH₃. Methods for preparing such polymerizable monomers of Formula (I) are known to those of ordinary skill in the relevant arts and are described in U.S. Pat. No. 9,102,774 (Clapper et al.), the contents of which are hereby incorporated by reference in their entirety. The aqueous pre-adhesive reaction mixtures, the polymerized products of the aqueous pre-adhesive reaction mixtures, and the adhesive compositions of the present disclosure include at least three structural isomers of a secondary (meth)acrylate of Formula (I).

In some embodiments, the monomer composition may further include one or more additional monomers that copolymerizes with acrylates. The additional monomer(s) are commonly selected to provide a reduced level of measurable adhesion to a selected substrate while still providing the level of tack of the adhesive polymer (i.e., the microsphere polymer), relative to the adhesive polymer without the one or more additional monomers. In other embodiments, the additional monomer(s) are selected to impart to the resulting adhesive polymer with a reduced level of tack while maintaining a substantially constant level of adhesion to a selected substrate, relative to the polymer without the one or more additional monomers. In still other embodiments, the additional monomer(s) are selected to impart to the resulting adhesive polymer an increased level of tack while maintaining a substantially constant level of adhesion to a selected substrate relative to the adhesive polymer without the one or more additional monomers. In some embodiments, the monomer that copolymerizes with acrylates may be a high Tg monomer.

In some embodiments, the high Tg monomers are selected from one or more high Tg monomers having a (meth)acryloyl group (i.e., a single (meth)acryloyl group). When used in combination with the (meth)acrylate monomers of Formula (I) described herein, such high Tg monomers may increase the overall Tg of the polymer and have been found to increase the modulus of polymers to which they are added, thus allowing characteristics of the material, such as, for example, the polymer's softness, to be modified.

Example high Tg monomers having a single (meth)acryloyl group include, but are not limited to, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, 2-phenoxyethyl methacrylate, and mixtures thereof. Suitable high Tg monomers for use in monomer compositions of the present disclosure generally have a homopolymer Tg of at least 25° C., optionally of at least 35° C., or optionally of at least 50° C. In some preferred examples, the high Tg monomer is isobornyl acrylate.

In some embodiments, the high Tg monomers may be present in a pre-adhesive reaction mixture in an amount of greater than 0 wt. %, or at least 1 wt. %, or at least 2 wt. %, or at least 3 wt. %, or at least 5 wt. %, based on the total weight of the monomers in the pre-adhesive reaction mixture. In some embodiments, the high Tg monomers may be present in a pre-adhesive reaction mixture in an amount of up to 20 wt. %, or up to 15 wt. %, or up to 10 wt. %, based on the total weight of the monomers in the pre-adhesive reaction mixture. Various intermediate levels are also possible, such as 4 wt. %, 6 wt. %, 11 wt. %, 13 wt. %, 16 wt. %, 19 wt. %, and all other such individual values represented by, for example, 1 wt. % increments between 0 wt-% and 20 wt-%, and in any range spanning these individual values in, for example, 1 wt-% increments, such as 2 wt-% to 4 wt-%, 11 wt-% to 20 wt-%, 7 wt-% to 17 wt-%, and the like. These amounts also apply to the amounts of reacted monomeric units in a microsphere polymer of the present disclosure, wherein the weight percentages are based on the weight of the polymer.

In embodiments of the monomer composition including both (meth)acrylates of Formula (I) and high Tg monomers, the mass ratio of (meth)acrylates of Formula (I):high Tg monomer in the monomer composition is typically 20:1, 19:1, 18:1, 17:1, 16:1, 15:1, 14:1 13:1, 12:1, 11:1, 10:1, 9:1, 8:1, 7:1, 6:1, 5:1, or 4:1. In some preferred embodiments, the mass ratio of (meth)acrylates of Formula (I):high Tg monomer in the monomer composition is at least 9:1 or at least 19:1.

In some embodiments, the monomer composition is present in the aqueous polymerizable pre-adhesive reaction mixture in an amount of at least 2 weight percent (wt. %), or at least 4 wt. %, or at least 6 wt. %, or at least 8 wt. %, or at least 10 wt. %, based on the total weight of the aqueous polymerizable pre-adhesive reaction mixture. In some embodiments, the monomer composition is present in the aqueous polymerizable pre-adhesive reaction mixture in an amount of up to 60 wt. %, or up to 55 wt. %, or up to 50 wt. %, or up to 40 wt. %, or up to 35 wt. %, or up to 30 wt. %, based on the total weight of the monomers in the pre-adhesive reaction mixture. Various intermediate levels are also possible, such as 3 wt. %, 5 wt. %, 7 wt. %, 9 wt. %, and all other such individual values represented by, for example, 1 wt. % increments between 2 wt. % and 60 wt. %, and in any range spanning these individual values in, for example, 1 wt. % increments, such as 2 wt. % to 4 wt. %, 7 wt. % to 60 wt. %, 20 wt. % to 25 wt. %, and the like.

Depending on the solubility of these monomers in water, the high Tg monomers can be dissolved in water, dispersed in water, or both.

### Stabilizer

The aqueous pre-adhesive reaction mixtures, the polymerized products of the aqueous pre-adhesive reaction mixtures, and the adhesive compositions of the present disclosure include one or more stabilizers. The stabilizers can be referred to as being “internally incorporated,” which means that the stabilizer is included in the polymerizable pre-adhesive reaction mixture and is present during the polymerization of the monomers used to form the microsphere polymers.

In some embodiments, a suspension of monomers is formed, and polymerization is carried out using thermal initiation of the polymerization reaction. The suspension is a water-in-oil or an oil-in-water suspension. In some such embodiments, the suspension is an oil-in-water suspension, wherein the monomers are stabilized in a bulk water phase by employing one or more stabilizers. Stabilizers useful in embodiments of the present disclosure can include, for example, inorganic stabilizers, surfactants, polymer additives, and combinations thereof.

In some embodiments, the stabilizer may be an inorganic stabilizer such as those used in Pickering emulsion polymerizations (e.g., colloidal silica).

In some embodiments, the stabilizer may be a polymer additive. Polymer additives useful in embodiments of the present disclosure may include, for example, polyacrylamide, polyvinyl alcohol, partially acetylated polyvinyl alcohol, hydroxyethyl cellulose, N-vinyl pyrrolidone, carboxymethyl cellulose, gum arabic, and mixtures thereof. In some embodiments, the polymer additive includes those sold under the trade name SUPERFLOC (e.g., SUPERFLOC N-300) by Kemira Oyj, Helsinki, Finland.

In some embodiments, the stabilizer may be a surfactant. In some embodiments, the surfactant may be anionic, cationic, zwitterionic, or nonionic in nature and the structure thereof not otherwise particularly limited. In some embodiments, the surfactant is also a monomer and becomes incorporated within the polymer microsphere molecules. In other embodiments, the surfactant is present in the polymerization reaction vessel but is not incorporated into the polymer microsphere as a result of the polymerization reaction.

Non-limiting examples of anionic surfactants useful in embodiments of the present disclosure include sulfonates, sulfolipids, phospholipids, stearates, laurates and sulfates. Sulfates useful in embodiments of the present disclosure include sulfates sold under the trade name STEPANOL by the Stepan Company, Northfield Ill., USA and HITENOL by the Montello, Inc., Tulsa, Okla., USA, and mixtures thereof.

Non-limiting examples of nonionic surfactants useful in embodiments of the present disclosure include block copolymers of ethylene oxide and propylene oxide, such as those sold under the trade names PLURONIC, KOLLIPHOR, or TETRONIC, by the BASF Corporation of Charlotte, N.C., USA; ethoxylates formed by the reaction of ethylene oxide with a fatty alcohol, nonylphenol, dodecyl alcohol, and the like, including those sold under the trade name TRITON, by the Dow Chemical Company of Midland, Mich., USA; oleyl alcohol; sorbitan esters; alkylpolyglycosides such as decyl glucoside; sorbitan tristearate; and combinations of one or more thereof.

Non-limiting examples of cationic surfactants useful in embodiments of the present disclosure include cocoalkylmethyl[polyoxyethylene (15)] ammonium chloride, benzalkonium chloride, cetrimonium bromide, demethyldioctadecylammonium chloride, lauryl methyl gluceth-10 hydroxypropyl diammonium chloride, tetramethylammonium hydroxide, monoalkyltrimethylammonium chlorides, monoalkyldimethylbenzylammonium chlorides, dialkylethylmethylammonium ethosulfates, trialkylmethylammonium chlorides, polyoxyethylenemonoalkylmethylammonium chlorides, and diquaternaryammonium chlorides; the ammonium functional surfactants sold by Akzo Nobel N.V. of Amsterdam, the Netherlands, under the trade names ETHOQUAD, ARQUAD, and DUOQUAD; and mixtures thereof.

In some embodiments, where a stabilizer is employed in an oil-in-water suspension polymerization reaction, it is employed in an amount of at least 0.01 wt. %, or at least 0.05 wt. %, or at least 0.1 wt. %, or at least 0.5 wt. %, or at least 1.0 wt. %, based on the total weight of solids in the aqueous polymerizable pre-adhesive reaction mixture. In some embodiments where a stabilizer is employed in an oil-in-water suspension polymerization reaction, it is employed in an amount of up to 5.0 wt. %, or up to 4.0 wt. %, based on the total weight of solids in the aqueous polymerizable pre-adhesive reaction mixture. Various intermediate levels are also useful, such as, for example, 1.1 wt-%, 1.2 wt-%, 1.3 wt-%, 1.4 wt-%, 1.5 wt-%, 1.6 wt-%, 1.7 wt-%, 1.8 wt-%, 1.9 wt-%, 2.1 wt-%, 2.2 wt-%, and all other such individual values represented by, for example, 0.01 wt. % increments between 0.01 and 5.0 wt. %, and in any range spanning these individual values in, for example, 0.1 wt. % increments, such as 2.3 wt. % to 4.6 wt. %, 4.5 wt. % to 4.7 wt. %, and the like.

### Polymerization Processes

The polymerization of the aqueous polymerizable pre-adhesive reaction mixture may be carried out using conventional suspension polymerization techniques familiar to those of ordinary skill in the relevant arts.

In some embodiments where thermal decomposition is employed to initiate polymerization, suspension polymerization of the monomers employed to make the polymer microspheres of the present disclosure may be carried out by blending the stabilizer(s) with water to provide an aqueous phase and blending the monomer composition and a thermal initiator to provide an oil phase. The aqueous phase and the oil phase may then be combined and stirred vigorously enough to form a suspension. The suspension may generally be formed, for example, by stirring the combined aqueous and oil phases with a 3-blade or 4-blade stirrer at a speed of 500 to 900 revolutions per minute (“rpm”). The suspension may then be heated to a temperature wherein decomposition of the initiator occurs at a rate suitable to sustain a suitable rate of polymerization (e.g., 60° C.).

Non-limiting examples of suitable thermal initiators include organic peroxides or azo compounds conventionally employed by those skilled in the art of thermal initiation of polymerization, such a dicumyl peroxide, benzoyl peroxide, or 2,2′-azo-bis(isobutyronitrile) (“AIBN”) and thermal initiators sold under the trade name VAZO by Chemours Canada Company, ON, Canada. Though in the case of suspension polymerization water-soluble initiators are often preferred, in some embodiments an oil-soluble initiator (e.g., 2-2′-azobis(2,4-dimethylvaleronitrile)) is preferred. The amount of initiator is typically in a range of 0.05 to 2 wt. % or in a range of 0.05 to 1 wt. %, or in a range of 0.05 to 0.5 wt % based on the total weight of monomers in the monomer composition.

In some embodiments, high-solids suspensions are formed, for example, at a solids content of at least 15 wt. %, or at least 25 wt. %, or at least 30 wt. %, solids in water. In some embodiments, high-solids suspensions are formed, for example, at a solids content of up to 60 wt. %, or up to 50 wt. %, solids in water. Various intermediate levels are useful, such as 16 wt. %, 17 wt. %, 18 wt. %, 19 wt. %, 20 wt. %, 21 wt. %, 22 wt. %, 23 wt. %, 24 wt. %, 26 wt. %, 27 wt. %, and all other such individual values represented by, for example, 1 wt. % increments between 15 wt. % and 60 wt. % solids in water, and in any range spanning these individual values in, for example, 1 wt. % increments, such as 23 wt. % to 46 wt. %, 45 wt. % to 57 wt. %, and the like.

In preferred embodiments, solids formed during polymerization of the aqueous polymerizable pre-adhesive reaction mixture may have an average particle size 20 μm to 100 μm, optionally 30 μm to 80 μm as measured by conventional means using, for example, a Horiba LA 910 particle size analyzer (Horiba, Ltd, Kyoto, Japan).

In some embodiments, water is present in the polymerizable pre-adhesive reaction mixture, for example, in an amount of at least 39.99 wt. %, or at least 45 wt. %, or at least 50 wt. %. In some embodiments, water is present in the polymerizable pre-adhesive reaction mixture, for example, in an amount of up to 89.99 wt. %, or up to 80 wt. %, or up to 70 wt. %, or up to 60 wt. %.

In general, conditions of suspension polymerization and methodology employed are the same or similar to those employed in conventional suspension polymerization methods. In some embodiments, the oil-in-water suspension polymerization is carried out using thermal initiation. In such embodiments, one useful polymerization initiator is 2-2′-azobis(2,4-dimethylvaleronitrile), which is a water-insoluble initiator (obtained from Chemours Canada Company, ON, Canada). In some such embodiments, the temperature of the suspension is adjusted prior to and during the polymerization is 30° C. to 100 C., or 40 C. to 80 C., or 40 C. to 70 C., or to 45° C. to 65° C. (e.g., 60° C.). In some embodiments, the peak temperature during the exotherm may reach as high as 110° C., or as high as 90° C., or as high as 75° C.

Agitation of the suspension at elevated temperature is carried out for a suitable amount of time to decompose substantially all of the thermal initiator and react substantially all of the monomers added to the suspension to form a polymerized suspension. In some embodiments, elevated temperature is maintained for a period of 1 hour to 48 hours, 2 hours to 24 hours, or 4 hours to 18 hours, or 8 hours to 16 hours.

During polymerization, it may be necessary in some embodiments to add additional thermal initiator to complete the reaction of substantially all of the monomer content added to the reaction vessel. It will be appreciated that completion of the polymerization is achieved by careful adjustment of conditions, and standard analytical techniques, such as gas chromatographic analysis of residual monomer content, will inform the skilled artisan regarding the completion of polymerization.

In other embodiments, the polymerization may occur in an aqueous mixture that may also include an organic solvent. Examples of suitable organic solvents and solvent mixtures include, in various embodiments, one or more of ethanol, methanol, toluene, methyl ethyl ketone, ethyl acetate, isopropyl alcohol, tetrahydrofuran, 1-methyl-2-pyrrolidinone, 2-butanone, acetonitrile, dimethylformamide, dimethyl sulfoxide, dimethylacetamide, dichloromethane, t-butanol, methyl isobutyl ketone, methyl t-butyl ether, and ethylene glycol. If used, no more than 10 wt-% organic solvent is used in the pre-adhesive reaction mixtures described herein.

### Adhesive Compositions and Coating

Adhesive compositions of the disclosure include a monomer composition including structural isomers of a secondary (meth)acrylate of Formula (I):

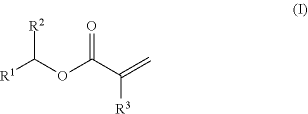

where R¹ and R² are each independently H or a C₁ to C₁₀ saturated linear alkyl group, the sum of the number of carbons in R¹ and R² is 7 to 18, inclusive, and R³ is H or CH₃, a stabilizer, and optionally one or more additional components. Additional components may include, for example, one or more adhesion promoters, surfactants, antifouling agents, thermal or oxidative stabilizers, colorants, adjuvants, plasticizers, solvents, tackifiers, crosslinkers (e.g., hexanediol diacrylate, butanediol diacrylate), or mixtures thereof.

In some embodiments, a polymer having a monomer composition including structural isomers of a secondary (meth)acrylate of Formula (I):

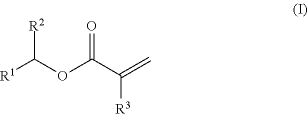

where R¹ and R² are each independently H or a C₁ to C₁₀ saturated linear alkyl group, the sum of the number of carbons in R¹ and R² is 7 to 18, inclusive, and R³ is H or CH₃, a stabilizer, and optionally one or more additional components, at the end of an suspension polymerization process, is employed as the adhesive composition and is coated as-is onto one or more supports to form a masking article. In preferred embodiments, the polymer may have an average particle size 20 μm to 100 μm, optionally 30 μm to 80 μm as measured by conventional means using, for example, a Horiba LA 910 particle size analyzer (Horiba, Ltd, Kyoto, Japan). In such embodiments, water and one or more surfactants employed in the polymerization will remain associated with the adhesive composition, along with any residual unreacted monomers or initiators. The adhesive composition is coated and dried for a period of time sufficient to remove a substantial portion of the water, but in most embodiments the surfactant(s) employed will remain in the dried coating whether or not such surfactants are reacted with and become part of the polymer.

Drying of the suspension will, in some embodiments, also result in removal of some portion or a substantial portion of any unreacted volatile monomers. In some embodiments, one or more additional components are added to the suspension polymer including monomer composition including structural isomers of a secondary (meth)acrylate of Formula (I):

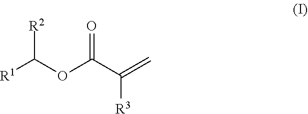

where R¹ and R² are each independently H or a C₁ to C₁₀ saturated linear alkyl group, the sum of the number of carbons in R¹ and R² is 7 to 18, inclusive, and R³ is H or CH₃, a stabilizer, and optionally one or more additional components, to form the adhesive composition, and the amended suspension is employed to coat one or more supports and dried to remove a substantial portion of the water and some or a substantial portion of any other remaining volatile components. In preferred embodiments, the suspension polymer may have an average particle size 20 μm to 100 μm, optionally 30 μm to 80 μm as measured by conventional means using, for example, a Horiba LA 910 particle size analyzer (Horiba, Ltd, Kyoto, Japan). After drying, it is desirable that the adhesive compositions include no more than 1 wt. %, for example, 0.5 wt. % to 5 ppm, or 500 ppm to 10 ppm, or 100 ppm to 1 ppm, of unreacted monomers, based on the total weight of monomers added to the suspension polymerization reaction vessel.

In certain embodiments, the adhesive coating contains the polymer including structural isomers of a secondary (meth)acrylate of Formula (I):

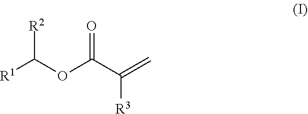

where R¹ and R² are each independently H or a C₁ to C₁₀ saturated linear alkyl group, the sum of the number of carbons in R¹ and R² is 7 to 18, inclusive, and R³ is H or CH₃, and 0.02 wt. % to 33 wt. % of the stabilizer based on the total weight of the polymer plus the stabilizer. In preferred embodiments, the polymer may have an average particle size 20 μm to 100 μm, optionally 30 μm to 80 μm as measured by conventional means using, for example, a Horiba LA 910 particle size analyzer (Horiba, Ltd, Kyoto, Japan). In some embodiments, the adhesive composition contains at least 70 wt. %, or at least 80 wt. %, or at least 85 wt. % polymer, based on the total weight of the polymer plus stabilizer. In some embodiments, the adhesive composition contains up to 98 wt. %, or up to 95 wt. % polymer, based on the total weight of the polymer plus the stabilizer. In some embodiments, the adhesive composition contains at least 0.05 wt. %, at least 1 wt. %, at least 2 wt. %, or at least 5 wt. % stabilizer, based on the total weight of the polymer plus the stabilizer. In some embodiments, the adhesive composition contains up to 30 wt %, up to 25 wt. %, up to 20 wt. %, or up to 15 wt. % stabilizer, based on the total weight of the polymer plus the stabilizer. In some embodiments, the adhesive composition contains 70 wt. % to 98 wt. % polymer plus 2 wt. % to 30 wt. % stabilizer, based on the total weight of the polymer plus the stabilizer. For example, the adhesive composition can contain 80 wt. % to 98 wt. % polymer and 2 wt. % to 20 wt. % phenolic resin, or 85 wt. % to 98 wt. % polymer and 2 wt. % to 15 wt. % stabilizer, or 85 wt. % to 95 wt. % polymer and 5 wt. % to 15 wt. % stabilizer.

The polymer in any of the adhesive compositions may contain the following monomeric units:

75 wt. % to 95 wt. %, based on the total weight of monomeric units, of at least three structural isomers of a secondary (meth)acrylate of Formula (I):

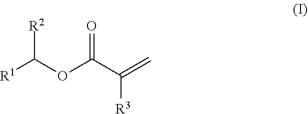

where R¹ and R² are each independently H or a C₁ to C₁₀ saturated linear alkyl group, the sum of the number of carbons in R¹ and R² is 7 to 18, inclusive, and R³ is H or CH₃, and 5 wt-% to 25 wt. %, based on the total weight of monomeric units, of one or more high Tg monomeric units derived from a high Tg monomer having a (meth)acryloyl group and having a Tg at least 25° C., optionally of at least 30° C., optionally of at least 50° C. when homopolymerized, or a mixture of two or more thereof.

In some embodiments, adhesive compositions of the present disclosure may further comprise at least one of a binder, a rheology modifier, a base, an antioxidant, and a biocide.

Binders useful in embodiments of the present disclosure may include binders such as those disclosed in U.S. Pub. No. 2003/0109630 (Smith et al.). In some embodiments, the binder may be a resin, a latex, or combinations thereof. Resins suitable for use as a binder in embodiments of the present disclosure may include, for example, relatively hard resins such as epoxies and nitrocellulose and/or relatively soft resins such as acrylates and vinyl ethers. In some embodiments, resins available from Lubrizol Corporation, Wickliffe, Ohio, USA, under the trade names HYCAR and CARBOTEC (e.g., CARBOTEC 26222) may be employed. Latexes suitable for use as a binder in embodiments of the present disclosure may include, for example, latexes prepared as described in U.S. Pat. No. 4,629,663 (Brown et al.), U.S. Pat. No. 3,857,731 (Merrill et al.) and U.S. Reissue Pat. No. 24,906 or available under the trade name FASTBOND Insulation Adhesive 49 from 3M Company, Saint Paul Minn., USA. Commonly the binder is present in the adhesive composition in amounts of 1 wt. % to 20 wt. % based on the total weight of solids in the adhesive composition.

Rheology modifiers useful in embodiments of the present disclosure may include anionic alkali-soluble associative thickeners, such as, for example rheology modifiers available commercially under the trade names ACRYSOL (e.g., ACRYSOL ASE 60, ACRYSOL TT935) and ACRYSOL HASE from Dow, Collegeville, Pa., USA, xanthan gums, such as those available under the trade name KELZAN S from CP Kelco, Atlanta, Ga., USA, hydrophobic modified acrylic swellable copolymer emulsions available commercially under the trade name RHEOVIS from BASF SE, Ludwigshafen, Germany, and combinations thereof. Commonly the rheology modifier is present in the adhesive composition in amounts of up to 2 wt. % based on the total weight of solids in the adhesive composition.

Bases useful in embodiments of the present disclosure may assist in adjustment of the viscosity of the adhesive composition and may include, for example, aqueous sodium hydroxide and/or aqueous ammonia (e.g., 10% aqueous NH₄OH). In some embodiments, the base may be used to adjust the pH of the adhesive composition to the range of pH 7 to pH 12 (e.g., pH 9.5) to achieve a desired viscosity. In some embodiments, the viscosity of the adhesive composition may be from 200 cP to 20000 cP (e.g., 9000 cP).

Antioxidants useful in embodiments of the present disclosure may be employed, for example, to slow and/or prevent oxidation of the adhesive composition due to exposure to elements such as, for example, heat and/or light. Useful antioxidants may include, for example, those available commercially under the trade name TI-NOX (e.g., TI-NOX WL) from Technical Industries, Peace Dale, R.I., USA or the trade name IRGANOX (e.g., IRGANOX 245 DW) from BASF Corporation, Charlotte, N.C., USA. The antioxidant may be present in the adhesive composition in amounts of 0.01 wt. % to 0.2 wt. % (e.g., 0.125 wt. %) based on the total weight of solids in the adhesive composition.

Biocides may be used in embodiments of the present disclosure, for example, to slow and/or prevent microbial fouling (e.g., fungi growth, mold growth) of the adhesive composition. Biocides useful in embodiments of the present disclosure may include, for example, those available commercially under the trade name ROCIMA (e.g., ROCIMA 607) from E. I. du Pont de Nemours and Company, Wilmington, Del., USA, the trade name ACTICIDE (e.g., ACTICIDE HF) from Thor Group Limited, Canterbury, UK, or the trade name SODIUM OMADINE from Lonza, Morristown, N.J., USA. The biocide may be present in the adhesive composition in amounts of 0.05 wt. % to 0.2 wt. % (e.g., 0.95 wt. %) based on the total weight of solids in the adhesive composition.

The viscosity and shear stability of the adhesive compositions of the disclosure provide broad flexibility in selecting coating methods for coating the adhesive compositions onto one or more supports to form a masking article. Non-limiting examples of useful coating processes employed in conjunction with the adhesive compositions include knife coating, slot coating, die coating, flood coating, rod coating, curtain coating, spray coating, brush coating, dip coating, kiss coating, gravure coating, print coating operations such as flexographic, inkjet, or screen print coating, and the like. In some embodiments the adhesive compositions are coated as a continuous coating; in other embodiments they are pattern coated.

Coating of an adhesive composition is followed by drying using a suitable temperature and period of time for drying that is sufficient to remove a substantial portion of the water and any other volatile substances associated with the suspension mixture.

In some embodiments, an adhesive composition of the present disclosure may include a first polymer prepared as described above and a second polymer prepared as described above, where the first polymer may have a first average particle size (e.g., 20 μm to 100 μm) and the second polymer may have a second average particle size (e.g., 30 μm to 80 μm) as measured by conventional means using, for example, a Horiba LA 910 particle size analyzer (Horiba, Ltd, Kyoto, Japan). In some embodiments, the first average particle size and the second average particle size may be different. In some embodiments, the first polymer and the second polymer may have the same formulation. In some embodiments, the first polymer and the second polymer may have different formulations.

### Adhesive Articles

The adhesive articles of the disclosure include at least an adhesive composition of the disclosure and a support. It is an advantage of the disclosure that adhesive articles of the disclosure are easy to make, in many embodiments employing a single pass coating operation to fabricate an adhesive article. In embodiments where the adhesive composition is coated as an suspension, the single coating pass is followed by a drying step. No additional steps are required in order to fabricate an adhesive article of the disclosure.

While the adhesive articles of the disclosure are not particularly limited as to type and shape of the support, in many embodiments the support is a sheet or film suitable for converting to a tape article. The supports may also be provided in roll form. Tape articles are rectangular strips that typically are converted from larger sheets or rolls into the desired width and length. Such conversion is typically carried out after coating the adhesive compositions onto the tape film or sheet. Variables in an adhesive coating process include film or sheet thickness of the support, chemical composition of the support, and nature of the adhesive composition to be coated.

The adhesive articles of the disclosure may be masking articles, whether or not they are used as such. In order to be used as a masking article, any of the adhesive articles described herein are useful as such with no further modification.

An adhesive article may be employed in any form or shape, including rectilinear, non-rectilinear shapes, and irregular shapes. Supports employed in forming adhesive articles of the disclosure are typically 12 micrometers to 3 centimeters (cm) thick, or 25 micrometers to 200 micrometers, or 75 micrometers to 150 micrometers thick for a “standard” dimension article, or 200 micrometers to 3 cm for specialized articles. Specialized adhesive articles include articles including a foamed support, for example.

Chemical composition of suitable supports includes those selected from a wide variety of polymers and blends thereof. Non-limiting examples of suitable supports include paper, including both flat or smooth paper as well as textured paper such as crepe paper, natural or synthetic polymer films, nonwovens made from natural and/or synthetic fibers and combinations thereof, fabric-reinforced polymer films, fiber- or yarn-reinforced polymer films or nonwovens, and multiple layer laminated constructions.

Examples of suitable synthetic polymer films include those made from polyolefins such as polyethylene or polypropylene, polyvinyl chloride, polytetrafluoroethylene and copolymers thereof with fluorinated and non-fluorinated monomers, polyvinylidene chloride and copolymers thereof, polyvinylidene fluoride and copolymers thereof, polyamides such as nylon 6, nylon 6,6, and nylon 12, polyesters such as polyethylene terephthalate, polylactic acid, and polyethylene naphthalate, polyimides, polyurethanes, polyacrylic esters, polycarbonates, and the like, and blends of two or more such materials. Such support materials include, in some embodiments, additional materials such as fillers, stabilizers, colorants, and the like. Metal supports, such as tin or aluminum film or sheet supports, are also useful in some embodiments. In some embodiments the polymers forming the support may be in the form of a foam support. In some embodiments the support is a metalized film. In some embodiments the support is a multilayered support having two or more layers; in some such embodiments the layers are laminated. Combinations of two or more such compositions and constructions are also useful in various embodiments of the disclosure.

In some embodiments, the support is embossed or micro-embossed; embossed or micro-embossed supports include any of the support materials and constructions described above. In some such embodiments, embossed or micro-embossed features are disposed on the major side of the support contacting the adhesive composition. In other embodiments, the embossed or micro-embossed features are disposed on the major side of the support opposite to the side coated with the adhesive composition. In still other embodiments, embossed or micro-embossed features are disposed on both major sides of the support; the features disposed on the two major sides are the same or different in various embodiments. In some embodiments, the adhesive composition itself includes embossed features, either by virtue of being coated on an embossed surface, or by disposing an adhesive composition between the support and an embossed release liner.

Embossed features imparted to the adhesive compositions themselves are useful, for example, to impart repositionability to the masking articles of the disclosure or allow for air bleed from between the adhesive article and the masked surface. Embossing and micro-embossing are accomplished using techniques known to the skilled artisan and include nip roll embossing using a patterned nip roll, and profile extrusion; secondary processes such as tentering and slicing are further employed in some embodiments to modify surface structures imparted by the embossing or micro-embossing process.

The width and length of the adhesive articles of the disclosure are not particularly limited. In some embodiments, the adhesive articles of the disclosure are converted to tape articles by slicing a coated sheet or film or roll to widths of 0.25 cm to 10 cm, or 0.5 cm to 7.6 cm; however, the width of a tape article is not particularly limited. Additionally, in some embodiments, the adhesive articles of the disclosure are suitably converted to smaller sheets or rolls, for example, 20 cm by 28 cm sheets, for use by a consumer. In some embodiments, sheets or rolls are provided to a consumer who is then free to divide the sheet or roll into the desired shape and dimensions for use in a specific application.

It is an advantage of the disclosure that the adhesive articles of the disclosure are masking articles, whether or not they are used as such. In order to be used as a masking article, any of the adhesive articles described are useful as such with no further modification.

The shapes easily utilized in conjunction with the supports onto which the adhesive compositions of the disclosure are coated are virtually unlimited in terms of ease of manufacturing and even ease of the end user in converting one supplied shape to a customized shape, for example, by hand cutting with scissors, a box cutter, a hole punch, a die cutter, or any other cutting implement. Thus, for example, a consumer could buy a 20 cm by 28 cm sheet of a masking tape of the disclosure and cut it into the desired shape for a specific end use. Such end uses include, for example, stenciling or patterning wherein the adhesive article is employed to mask an area to be painted and is removed after the paint is applied.

In some embodiments, prior to coating and drying the adhesive compositions of the disclosure on the support, the support is pre-treated. Pre-treatments are applied to, or carried out on, the major surface of the support onto which the adhesive composition will be coated, when an increase in the adhesive bonding between the support and the adhesive composition is necessary to prevent failure of the support-adhesive interface when a tape article or other masking article is removed from the surface onto which it was applied in use.

Pre-treatments include coatings applied to the support surface. One of skill will understand that the nature of such “primer” coatings is specific to each support and specific adhesive composition, and a wide variety of such primer coatings are available—in fact, some support materials are available pre-primed for this purpose. Another type of suitable pre-treatment is roughening the surface of the support prior to coating, which increase surface area for adhesion by the coated adhesive compositions of the disclosure. Yet another type of suitable pre-treatment is corona or plasma treatment of the surface to induce chemical changes that can increase adhesion of the adhesive compositions of the disclosure to the support. While such pre-treatments are useful in some embodiments, in other embodiments many suitable supports, including paper, polyethylene terephthalate, polyvinyl chloride, and polycarbonate, are coated with the compositions in the absence of any type of pre-treatment to improve bonding at the support-adhesive interface.

In some embodiments, where the adhesive article is a tape, the major side opposite the side of the support onto which the adhesive composition will be coated is treated in order to facilitate release of the adhesive from the major side opposite to the adhesive-coated side during unwinding of the tape by the end user. Such coatings, often termed “low adhesion backside” or LAB in the industry, are well known by those of skill and any of the conventionally employed LAB treatments and coatings are suitably applied to the tape supports employed to form the masking tape articles of the disclosure. Conventional LAB treatments are suitably employed in various embodiments of the disclosure to provide tape articles having conventional values of unwind force, for example, of 50 grams per centimeter (g/cm) to 500 g/cm, or 100 g/cm to 350 g/cm, when measured at 1800 peel at a rate of 228.6 cm/min and set time of 5 seconds.

In some embodiments, the adhesive article includes a release liner. For example, in some embodiments, it is desirable to form the adhesive article in sheet form, or it is useful for some other reason to avoid having the adhesive article wound upon itself as is commonly done with adhesive tapes. For example, if the end use is a stenciling application, it is generally desirable to employ a release liner—that is, a separate support-type sheet or film—applied to the coated and dried adhesive composition residing on the support. In such embodiments, the support is coated on one major side thereof with the adhesive composition, the adhesive composition is dried if necessary, and a release liner is applied on top of the dried adhesive layer. The release liner is formed from, or coated with, a material that releases cleanly from the adhesive when peeled off by the end user, in embodiments transferring substantially no residue of the release liner material on or in the adhesive. Such release liners are well known by those of skill and any of the conventionally employed release liners are suitably applied to the tape supports employed to form the masking tape articles of the disclosure.

In embodiments where the adhesive article is a tape article, the adhesive compositions of the disclosure are coated onto the selected support at coating weights of 5 grams per square meter (g/m²) to 90 g/m², or 10 g/m² to 70 g/m², or 15 g/m² to 50 g/m², of the dried adhesive composition on the support. However, it will be understood that the adhesive articles of the disclosure are not limited to masking tape articles or to masking applications, and for various applications a thicker or thinner coating of the adhesive is useful and is easily optimized by one of skill.

In some embodiments the adhesive compositions of the disclosure are coated discontinuously on a major side of a support onto which no additional adhesive is coated. Pattern coating and stripe coating are useful in some embodiments to provide an “edge-coated only” adhesive article wherein one or both edges of a tape support are coated with the adhesive composition. Such articles have pressure sensitive adhesive performance over only a portion of the major side that contacts a surface in a masking application, and no adhesion at all over the remainder thereof. In some embodiments, edge-coated only adhesive articles reduce the total amount of coated material per unit of area in forming the tape construction. In some embodiments, an edge-coated only adhesive article has a reduced adhesive force per unit of tape area, which in turn aids in removing the article from a surface after application. In some embodiments, by using an edge-coated only masking article, a surface can effectively be masked wherein adhesive does not contact, for example, a very delicate portion of the surface. Such articles are useful, for example, in highly sensitive applications such as artwork restoration, painting of surfaces contiguous to delicate fabrics, painting of surfaces contiguous to very old woodwork having an original finish or protecting semiconductor surfaces during coating processes. Because in such edge-coated only articles the edge coating is itself a pressure sensitive adhesive, such masking articles can be formed.

An additional advantage of the edge-coated adhesive articles of the disclosure is that the adhesive force of the edge coating (as evidenced by, e.g., peel adhesion level) is easily adjusted in the same manner as described above for the supports coated entirely with the adhesive compositions of the disclosure. Thus, for example, a masking article is easily formed wherein the edges of the coated major side thereof have a greater or lesser amount of adhesive force to the intended substrate compared to the additional adhesive disposed on at least a portion of the remainder of the major side. Similarly, a masking article is easily formed wherein the edges of the coated major side thereof have a greater or lesser amount of tack compared to the additional adhesive disposed on at least a portion of the remainder of the major side.

In various embodiments, the edge-coated adhesive articles are suitably coated with the adhesive compositions of the disclosure at coating weights of 1 g/m² to 90 g/m², or 5 g/m² to 70 g/m², or 10 g/m² to 50 g/m², of the dried adhesive composition. However, it will be understood that the edge-coated adhesive articles of the disclosure are not limited to masking tape articles or to masking applications, and for various applications a thicker or thinner coating of the adhesive composition is useful and is easily optimized by one of skill. Further, the width of the edge coating is not particularly limited; that is, the distance between the outer edge of the major coated surface and the inner edge of the edge coating can encompass any percent of the total width of the support that is less than 100%. In some embodiments, the edge coating encompasses 5% to 50% of the total width of the support.

Edge coating of the adhesive compositions is suitably carried out using any method known to those of skill. For example, stripe coating, knife coating, brush coating, kiss coating, die coating, or curtain coating are useful means to apply the adhesive compositions of the disclosure to the edges of a support.

In some embodiments, a method of making an adhesive article including adhesive compositions of the present disclosure may include the steps of: 1) forming an aqueous polymerizable pre-adhesive reaction mixture according to the above disclosure; 2) polymerizing the monomers in the pre-adhesive reaction mixture to form a polymerized mixture, where the average particle size of polymers in the polymerized mixture is 20 μm to 100 μm, optionally 30 μm to 80 μm; 3) coating the polymerized mixture onto a support to form a coated mixture; and 4) drying the coated mixture.

In some embodiments, and as described above, adhesive compositions of the present disclosure may further comprise at least one of a binder, a rheology modifier, a base, an antioxidant, and a biocide. Therefore, in some embodiments, the method of making an adhesive article including adhesive compositions of the present disclosure may further include the step of adding at least one of the binder, the rheology modifier, the base, the antioxidant, or the biocide to the polymerized mixture, i.e., after step 3 is completed, a process that may be referred to as “compounding.”

### Applications of the Adhesive Articles

In various embodiments, the adhesive articles of the disclosure are applied to a selected substrate, whereupon the adhesive composition performs as a pressure-sensitive adhesive. Pressure-sensitive adhesives are recognized as a standard class of materials. Pressure-sensitive adhesives are generally recognized as having tack at temperatures ranging from 15° C. to 25° C. and adhesion to a variety of dissimilar surfaces upon mere contact without the need for more than manual pressure. Pressure-sensitive adhesives require no activation by water, solvent, or heat in order to exert a strong adhesive holding force towards materials such as paper, cellophane, glass, plastic, wood, and metal. Pressure-sensitive adhesives have a sufficiently cohesive holding and elastic nature that, despite their aggressive tackiness, they can be handled with the fingers and removed from smooth surfaces without leaving a substantial residue (see, e.g., Test Methods for Pressure sensitive Tapes, 6th Ed., Pressure Sensitive Tape Council, 1953). Pressure sensitive adhesives and tapes are well known, and the wide range and balance of properties desired in such adhesives has been well analyzed (see, e.g., U.S. Pat. No. 4,374,883 (Winslow et al.); and “Pressure sensitive Adhesives” in Treatise on Adhesion and Adhesives Vol. 2, “Materials,” R. I. Patrick, Ed., Marcel Dekker, Inc., N.Y., 1969).

Substrates on which the adhesive compositions of the disclosure have good performance as a pressure-sensitive adhesive, when combined with a suitable support in an adhesive article, include, but are not limited to, glass, metal, wood (including wood products such as cardboard or particleboard), drywall, synthetic or natural polymers including filled, colored, crosslinked or surface-modified polymers including, for example, polyvinyl chloride, polyesters such as polyethylene terephthalate or polylactic acid, natural or synthetic rubber, polyamides, polyolefins such as polyethylene or polypropylene, appliance or equipment casing materials such as acrylonitrile-butadiene-styrene (“ABS”) copolymers, polycarbonate, polymethyl methacrylate, and the like; and mixed or composite materials such as polymer-wood composites, and the like, and any painted and/or primed surface thereof.

Once applied to the selected substrate surface, the adhesive articles of the disclosure may be usefully employed in one or more masking applications. The performance of the adhesive articles of the disclosure as masking articles is characterized by the interaction of the adhesive compositions of the disclosure with the liquid and/or liquid-borne solid materials applied to the masked substrate, wherein the interaction results in the substantial prevention of contact by the liquid or liquid-borne materials with the masked surface. To use the masking article to produce sharp, clean, smooth lines of separation between a masked substrate, which is shielded from a coating, and the unmasked region of the substrate to which a liquid coating is applied, the adhesive article is first adhered to the region of the substrate to be shielded from the coating. Next, the coating is applied to the unmasked region of the substrate and applied to at least the edge of the adhesive article. The coating is then allowed to at least partially dry. Last, the adhesive article is removed from the substrate. Because the adhesive article inhibits the migration of the coating beyond the edge of the masked surface, a clear even line of demarcation is produced between the coated region of the substrate and the masked surface of the substrate.

Another aspect of the masking application is removal of the masking article after the coating operation(s) are carried out. It is a feature of the adhesive articles of the disclosure that regardless of the substrate onto which the adhesive article is applied, removal is substantially clean—that is, there is no observable residue left upon removal of the article, and there is no damage to the substrate as a result of removing the adhesive article. Importantly, there is no observable residue left around the masked surface at the edge of the masked surface when the adhesive articles of the disclosure are removed from a substrate after carrying out a masking application.

Objects and advantages of this disclosure are further illustrated by the following non-limiting examples, but the particular materials and amounts thereof recited in these examples, as well as other conditions and details, should not be construed to unduly limit this disclosure. °=degree, in.=inch, lb.=pound, min.=minute, g=grams, ° C.=degrees Celsius, RH=relative humidity, mL=milliliters, %=percentage, L=liter, rpm=revolutions per minute.

### EXAMPLES

Unless otherwise noted, all parts, percentages, ratios, etc. in the Examples and the rest of the specification are by weight.

TABLE 1
Materials

| Abbreviation | Description and Source |
|---|---|
| C12 Acrylates | Blend of C12 acrylates prepared as described in U.S. Pat. No. 9,102,774 |
| | (Clapper et al.) |
| LA | Lauryl acrylate, obtained as SR335 from Sartomer, Exton PA, USA |
| IBOA | Isobornyl acrylate, Osaka Chemical Co., Japan |
| STEPANOL AMV | Ammonium lauryl sulfate, Stepan Company, Northfield IL, USA |
| HITENOL BC 1025 | Polyoxyethylene alkylphenyl ether ammonium sulfate, Montello, Inc., Tulsa, |
| | OK, USA |
| IOA | Isooctyl acrylate, 3M Company, Saint Paul MN, USA |
| EHA | 2-Ethylhexylacrylate, BASF, Ludwigshafen, Germany |
| CYANAMERN-300 | Polyacrylamide, available commercially under the trade designation |
| | SUPERFLOC N-300, Kemira Oyj, Helsinki, Finland |
| VAZO 52 | 2-2′-Azobis(2,4-dimethylvaleronitrile), Chemours Canada Company, ON, |
| | Canada |
| ACRYSOL ASE 60 | Rheology modifier available under the trade name ACRYSOL ASE 60 from |
| | Dow, Collegeville, PA, USA |
| FASTBOND 49 | A binder available under the trade name FASTBOND Insulation Adhesive 49 |
| | from 3M Company, Saint Paul MN, USA |
| Ionomer latex | Ionomer latex prepared as described in U.S. Pat. No. 4,629,663 (Brown et al.) |
| 10% aq. NH₄OH | Ammonia in water (10% w/v), Ricca, Arlington, TX, USA |
| 3-blade stirrer | 3-blade trailing edge stirrer, 3M Company, Saint Paul MN, USA |
| 4-blade stirrer | 4-blade 45° pitched blade stirrer, 3M Company, Saint Paul MN, USA |
| Paper | 2093 paper backing, 3M Company, Saint Paul MN, USA |
| Primer | PROMAR 200 Zero VOC Primer B28W02600, Sherwin Williams, Cleveland |
| | OH, USA |
| Drywall | Drywall, United States Gypsum, Chicago IL, USA |
| Ben Bone | DURATION Ben Bone Matte paint, Sherwin Williams, Cleveland, OH |
| PROMAR | PROMAR 200 Zero VOC Extra White Eg-Shel paint, Sherwin Williams, |
| | Cleveland OH, USA |
| Overpaint | PROMAR 200 Zero VOC Black Eg-Shel paint, Sherwin Williams, Cleveland |
| | OH, USA |
| FROG Green | FROGTAPE Multi-Surface Painting Tape, ShurTech Brands, LLC, Avon, OH, |
| | USA |
| FROG Yellow | FROGTAPE Delicate Surface painter’s tape, ShurTech Brands, LLC, Avon, |
| | OH, USA |
| 2093 | 3M SCOTCHBLUE 2093 Painter’s Tape, 3M Company, Saint Paul MN, USA |
| 2090 | 3M SCOTCHBLUE 2090 Painter’s Tape, 3M Company, Saint Paul MN, USA |

### Test Methods

### Particle Size Measurements

Microsphere particle-size measurements were performed using a Horiba LA 910 particle size analyzer (Horiba, Ltd, Kyoto, Japan).

### Holding Power Test Method

Holding power of tapes in the disclosed Examples was measured by adhesion at a constant angle and stress (“ACAS”) at 20° decline with respect to the direction of gravity. A weight was attached to the top portion of a strip of tape (4 in.×1 in.) that had been adhered to painted drywall by rolling the tape down with a 4.5 lb. roller for two passes at roughly 30 in./min rolldown speed. The time required to completely remove the strip of tape from the substrate was recorded. Typically, a 50 g weight was used for ACAS experiments.

### Painted Drywall Preparation

A ⅜ in. standard drywall was painted with primer using a ⅜ in. nap roller. The primer was allowed to dry for at least a day. Two coats of Ben Bone paint or PROMAR paint were applied to the drywall, allowing the paint to dry to the touch between coats. The painted drywall was allowed to dry at ambient conditions for at least seven days prior to testing.

### Paint Line Determination

Drywall was prepared by painting as described above. Tapes were applied to painted drywall with a 4.5 lb. roller for two passes at roughly 30 in./min. The tapes were overpainted with black overpaint using a premium Purdy paintbrush and allowed to dry overnight. Tapes were removed and the paint line quality was visually assessed.

### Peel Adhesion

Peel adhesion data were gathered using an IMASS (IMASS INC., Accord, Mass.) at 90 in./min. platen speed and 180° peel angle. The tape was adhered to the substrate using a 4.5 lb. roller for two passes at roughly 30 in./min. rolldown speed.

### Damage Testing

Damage testing was conducted by applying tapes to painted wallboard, applying a light overcoat of the base paint over the tapes allowing the samples to dwell at the given environmental condition for seven days, and removing the tapes at the appropriate angle at a peel rate of at least 90 in./min. Tapes were removed by hand, contributing to some variability in the rate and angle in which the tape was removed. At least three replicates were performed.

### Tape Coating Process

All Example tape constructions were coated on a paper backing including a primer and release coat. Adhesives were knife coated using a 4-mil wet gap or using a fluid bearing die and were dried at 70° C. for 5 minutes. The tapes were then slit into 1″ rolls and stored under constant temperature and humidity conditions (25° C., 50% RH) for at least 1 week prior to testing.

### Example 1: Preparation of Microsphere Adhesives (“MSAs”) A1-A8 and Comparative Examples CE1-CE3

A 500 mL resin flask (4″ diameter) was charged with STEPANOL AMV, HITENOL BC 1025, CYANAMER N300, and water in amounts as shown in Table 2 to provide an aqueous phase. In a separate flask, an oil phase was prepared by mixing C12 Acrylates, IBOA, LA, EHA, IOA, and VAZO 52 in amounts as shown in Table 2. After complete mixing with a TEFLON-coated magnetic stir bar, the oil phase was added to the aqueous phase all at once. An overhead stirrer equipped with a glass trailing edge stir rod was used to mix the phases at a rate as disclosed in Table 3. During the agitation, the multi-phase mixture was degassed by sparging with nitrogen for 30 minutes. After degassing, the mixture was heated to 60° C. The peak temperature during the exotherm typically reached as high as 75° C. The mixture was allowed to cool to 60° C. and was then maintained at that temperature for 8 hours. The mixture was cooled to room temperature and compounded as described in Example 2.

TABLE 2
Adhesive Mixtures

| | Stabilizer Package (g) | | | | | | | | | |
|---|---|---|---|---|---|---|---|---|---|---|
| | | | 1 wt. % aq. | Monomers (g) | | | | | | |
| Adhesive | STEPANOL | HITENOL | CYANAMER | C12 | | | | | Water | VAZO 52 |
| Mixture | AMV | BC 1025 | N-300 | Acrylate | IBOA | LA | EHA | IOA | (g) | (g) |
| A1 | 1.0 | 0 | 0 | 200 | 10.5 | 0 | 0 | 0 | 211 | 0.2 |
| A2 | 2.1 | 2.1 | 13.3 | 200 | 10.5 | 0 | 0 | 0 | 211 | 0.2 |
| A3 | 2.1 | 2.1 | 0 | 200 | 10.5 | 0 | 0 | 0 | 211 | 0.2 |
| A4 | 2.1 | 2.1 | 13.3 | 200 | 10.5 | 0 | 0 | 0 | 211 | 0.2 |
| A5 | 2.1 | 2.1 | 13.3 | 168 | 42.2 | 0 | 0 | 0 | 211 | 0.2 |
| A6 | 2.1 | 0 | 0 | 200 | 10.5 | 0 | 0 | 0 | 211 | 0.2 |
| A7 | 4.2 | 4.2 | 0 | 380 | 42.2 | 0 | 0 | 0 | 420 | 0.4 |
| A8 | 4.2 | 4.2 | 0 | 400 | 21.0 | 0 | 0 | 0 | 420 | 0.4 |
| CE1 | 2.1 | 2.1 | 13.3 | 0 | 10.5 | 0 | 0 | 200 | 211 | 0.2 |
| CE2 | 2.1 | 2.1 | 13.3 | 0 | 10.5 | 0 | 200 | 0 | 210 | 0.2 |
| CE3 | 4.2 | 4.2 | 0 | 0 | 0 | 400 | 0 | 0 | 420 | 0.4 |

TABLE 3
Microsphere Particle Sizes

| | | Particle | | |
|---|---|---|---|---|
| | Average | Diameter | | |
| | Particle | Standard | | |
| Adhesive | Diameter | Deviation | Stir Speed | |
| Mixture | (□m) | (□m) | (RPM) | Stir Rod Type |
| A1 | 76 | 33 | 800 | 3-blade stirrer |
| A2 | 78 | 34 | 500 | 3-blade stirrer |
| A3 | 95 | 44 | 500 | 3-blade stirrer |
| A4 | 54 | 32 | 500 | 4-blade stirrer |
| A5 | 86 | 39 | 550 | 3-blade stirrer |
| A6 | 79 | 40 | 500 | 3-blade stirrer |
| A7 | 57 | 33 | 700 | 3-blade stirrer |
| A8 | 39 | 18 | 900 | 3-blade stirrer |
| CE1 | 73 | 35 | 500 | 3-blade stirrer |
| CE2 | 79 | 39 | 500 | 3-blade stirrer |
| CE3 | 52 | 21 | 700 | 3-blade stirrer |

### Example 2: Preparation of Compounded Formulations F1-F8 and Comparative Compounded Formulations CEF1-CEF3

The heterogeneous MSA adhesive mixtures A4-A8 and CE1-CE2 were agitated to disperse the particles immediately before use. Agitated MSA adhesive mixture (180 g) was added to a 400 mL HDPE bottle. To the MSA adhesive mixture a binder latex (20 g, ˜50% solids in water) was added, followed by the addition of ACRYSOL ASE-60 (2 g). The solution was mixed on a jar roller for about 5 minutes followed by the addition of aqueous ammonia (1 mL, 10% in water). The solutions were rolled on a jar roller at 10-30 rpm at room temperature for at least 12 hours before coating. Compounded formulations are shown in Table 4.

TABLE 4
Compounded Formulations

| | MSA | MSA Adhesive | Ionomer | | ACRYSOL | 10% (w/v) Aq. |
|---|---|---|---|---|---|---|
| | Adhesive | Mixture Mass | Latex | FASTBOND | ASE- 60 | Ammonia |
| Formulation | Mixture | (g) | (g) | 49 | (g) | (mL) |
| F1 | A1 | 180 | 20 | 0 | 2 | 1 |
| F2 | A2 | 180 | 20 | 0 | 2 | 1 |
| F3 | A3 | 180 | 20 | 0 | 2 | 1 |
| F4 | A4 | 180 | 20 | 0 | 2 | 1 |
| F5 | A5 | 180 | 20 | 0 | 2 | 1 |
| F6 | A6 | 180 | 20 | 0 | 2 | 1 |
| F7 | A7 | 180 | 20 | 0 | 2 | 1 |
| F8 | A8 | 180 | 0 | 20 | 2 | 1 |
| CEF1 | CE1 | 180 | 20 | 0 | 2 | 1 |
| CEF2 | CE2 | 180 | 20 | 0 | 2 | 1 |
| CEF3 | CE3 | 180 | 0 | 20 | 2 | 1 |

TABLE 6
Rheological Properties

| | | G’ at 25° C., 1 rad/s |
|---|---|---|
| Formulation | T_{g} (° C.) | (kPa) |
| Fl | −42 | 22.2 |
| F2 | −42 | 21.4 |
| F3 | NA | NA |
| F4 | NA | NA |
| F5 | −32 | 27.0 |
| F6 | NA | NA |
| F7 | −39 | 21.6 |
| F8 | NA | NA |
| CEF1 | −39 | 33.1 |
| CEF2 | −39 | 34.7 |
| CEF3 | NA | 25 |

TABLE 7
Tapes

| | Compounded | |
|---|---|---|
| | Adhesive | |
| Tape Name | Formulation | Backing |
| T1 | F1 | Paper |
| T2 | F2 | Paper |
| T3 | F3 | Paper |
| T4 | F4 | Paper |
| T5 | F5 | Paper |
| T6 | F6 | Paper |
| T7 | F7 | Paper |
| T8 | F8 | Paper |
| CET1 | CEF1 | Paper |
| CET2 | CEF2 | Paper |
| CET3 | CEF3 | Paper |

TABLE 8
Tape performance

| | | Standard | | Standard | | |
|---|---|---|---|---|---|---|
| | | Deviation | | Deviation | | |
| | Peel Adhesion | Adhesion to | ACAS to | ACAS to | | |
| | to Ben Bone | Ben Bone | Ben Bone | Ben Bone | Paint Line | Damage to |
| Tape | (oz/inch) | (oz/inch) | (min) | (min) | to PROMAR | Valspar Ultra |
| T1 | 18.01 | 0.47 | 464 | 121 | Excellent | None |
| T2 | 21.42 | 3.21 | 5852 | 3515 | Excellent | None |
| T3 | 22.72 | 0.50 | 2018 | 1892 | Excellent | None |
| T4 | 17.19 | 0.73 | 68 | 0.6 | Excellent | None |
| T5 | 24.31 | 1.64 | 3117 | 2164 | Poor | Yes |
| T6 | 16.36 | 0.40 | 70 | 3 | Excellent | None |
| T7 | 18.28 | 0.03 | 398 | 195 | Excellent | None |
| T8 | 14.63 | 0.55 | 1251 | 908 | Excellent | None |
| CET1 | 17.95 | 1.00 | 133 | 45 | Poor | None |
| CET2 | 21.84 | 0.57 | 105 | 31 | Poor | None |
| CET3 | 7.33 | 0.73 | 2 | 0.4 | Poor | None |

TABLE 9
Commercially Available Comparative Examples

| | | | | | ACAS | | |
|---|---|---|---|---|---|---|---|
| | | | | | Standard | | |
| | | | | ACAS to | Deviation to | | |
| Comparative | Tape | | Standard | Ben Bone, | Ben Bone, | | Damage |
| Example | Name | Peel | Deviation | min | min | Paint line | (Yes/No) |
| CET4 | 2093 | 18.23 | 0.65 | 11 | 1 | Poor | Yes |
| CET5 | 2090 | 12.69 | 1.09 | 312 | 120 | Poor | Yes |
| CET6 | Frog Green | 22.12 | 0.60 | 2072 | 610 | Excellent | No |
| CET7 | Frog Yellow | 15.05 | 0.36 | 6 | 1 | Excellent | No |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An aqueous polymerizable pre-adhesive reaction mixture comprising:
a stabilizer; and
a monomer composition including at least three structural isomers of a secondary (meth)acrylate monomer of Formula (I): 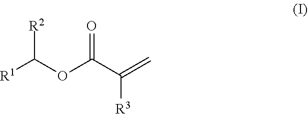
wherein
R¹ and R² are each independently H or a C₁ to C₁₀ saturated linear alkyl group;
the sum of the number of carbons in R¹ and R² is 7 to 18, inclusive; and
R³ is H or CH₃.

2. The aqueous polymerizable pre-adhesive reaction mixture of claim 1, wherein the stabilizer is selected from the group consisting of a surfactant, a polymer additive, and combinations thereof.

3. The aqueous polymerizable pre-adhesive reaction mixture of claim 1, the monomer composition further comprising a high Tg monomer having a homopolymer Tg of at least 25° C., optionally of at least 35° C., or optionally of at least 50° C.

4. The aqueous polymerizable pre-adhesive reaction mixture of claim 1, the reaction mixture further comprising an initiator.

5. The aqueous polymerizable pre-adhesive reaction mixture of claim 4, wherein the initiator comprises an oil-soluble initiator.

6. The aqueous polymerizable pre-adhesive reaction mixture of claim 1, the reaction mixture comprising:
39.99 wt. % to 89.99 wt. % water based on the total weight of the aqueous polymerizable pre-adhesive reaction mixture; and
0.01 wt. % to 5 wt. % of the stabilizer, based on the total weight of the solids in the aqueous polymerizable pre-adhesive reaction mixture.

7. The aqueous polymerizable pre-adhesive reaction mixture of claim 3, the reaction mixture comprising up to 20 wt. % of the high Tg monomer based on the total weight of the monomer composition.

8. The aqueous polymerizable pre-adhesive reaction mixture of claim 4, the aqueous polymerizable pre-adhesive reaction mixture comprising 0.01 wt. % to 2 wt. % of the initiator based on the total weight of the aqueous polymerizable pre-adhesive reaction mixture.

9. A polymerized product of the aqueous polymerizable pre-adhesive reaction mixture of claim 1.

10. The polymerized product of claim 9, wherein the average particle size is 20 μm to 100 μm, optionally 30 μm to 80 μm.

11. An adhesive composition comprising the polymerized product of claim 9.

12. An adhesive composition comprising a first polymerized product of claim 10, the first polymerized product having a first average particle size, and a second polymerized product of claim 10, the second polymerized product having a second average particle size, wherein the first average particle size is different from the second average particle size.

13. The adhesive composition of claim 11, further comprising 1 wt. % to 20 wt. % of a binder based on the total weight of solids in the adhesive composition.

14. The adhesive composition of claim 11, further comprising up to 2 wt. % of a rheology modifier based on the total weight of solids in the adhesive composition.

15. The adhesive composition of claim 11, further comprising a base.

16. An adhesive article comprising a support having first and second opposed major surfaces and an adhesive composition of claim 11, wherein the adhesive composition is disposed on at least a portion of at least one of the first and second major surfaces.

17. A method of making an adhesive article, the method comprising:
forming an aqueous polymerizable pre-adhesive reaction mixture according to claim 1;
polymerizing the monomers in the pre-adhesive reaction mixture to form a polymerized mixture, wherein the average particle size of polymers in the polymerized mixture is 20 μm to 100 μm, optionally 30 μm to 80 μm;
coating the polymerized mixture onto a support to form a coated mixture; and
drying the coated mixture.

18. The method of claim 17, further including the step of adding a material selected from the group consisting of a binder, a base, a rheological modifier, an antioxidant, a biocide, and combinations thereof to the polymerized mixture.

19. The method of claim 18, wherein the material is a binder.
